(19) United States
(12) Patent Application Publication
(10) Pub. No.: US 2023/0372746 A1
(43) Pub. Date: Nov. 23, 2023

(54) FACE MASK APPARATUS

(71) Applicant: CHIH-FANG LO, TAICHUNGCITY (TW)

(72) Inventor: CHIH-FANG LO, TAICHUNGCITY (TW)

(21) Appl. No.: 17/751,621

(22) Filed: May 23, 2022

(51) Int. Cl. A62B 18/00; A41D 13/11; A62B 7/10

(52) U.S. Cl. CPC A62B 18/006; A41D 13/1161; A62B 7/10

(57) ABSTRACT

A face mask apparatus is provided for protecting the user from viruses, bacteria, dust, etc. The face mask apparatus includes a base mask, a gas supply pump and a connecting tube. The base mask includes a shielding surface, a breathing chamber and a pair of ear straps. By virtue of pumping the air into the sealed base mask with the external gas supply pump for inhalation and expelling the excess air through a plurality of air passageway, the face mask apparatus of the present disclosure shields infiltration of the external viruses and bacteria from the slit of the mask.

### FIELD OF THE DISCLOSURE

The present disclosure relates to a power pumped face mask apparatus, in particular to a face mask apparatus that can prevent external dust, bacteria, viruses, etc. from entering the inside space of the face mask.

### BACKGROUND OF THE DISCLOSURE

With the advancement of times, face masks have become the indispensable items in life. Whether it is worn to protect others when sick, or to prevent self-infection and prevent sand and dust from entering the respiratory system, face masks play a role in protecting users themselves and others.

With the epidemic of the COVID-19 in recent years, many countries and regions have advocated wearing face masks for epidemic prevention. However, although the commercial masks are lighter and cheaper, there are still plenty of people who have difficulty breathing with masks and refuse to wear masks. In addition, commercially ordinary masks are relatively poor or ineffective in dust protection and seal airtight.

Therefore, the present disclose is to optimize and improve the above-mentioned problems, further increase the breathing comfort and the area of protection when wearing a mask, which can effectively reduce the user's anxiety and increase the user's comfort when wearing a mask.

### SUMMARY OF THE DISCLOSURE

The main objective of the present disclosure is to provide a face mask apparatus, by virtue of pumping the air into the sealed base mask with the external gas supply pump for inhalation and expelling the excess air through the air passageway, the face mask apparatus of the present disclosure prevents the user from the risks of inhaling the bacteria, viruses, dust, etc. directly. Moreover, since the air is pumped into the face mask directly, the user will not breath difficultly as with the ordinary mask, so that the face mask apparatus of the present disclosure reduces discomfort and increases acceptance of wearing masks for the user.

In order to achieve the objective and effort mentioned above, the present disclosure provides a face mask apparatus, including: a base mask, including a shielding surface facing outward and shielding the outside air into the base mask; a breathing chamber opposite to the shielding surface; and a pair of ear straps disposed on two sides of the base mask respectively; wherein, the base mask further includes a ventilation portion, and a communicating portion penetrating through the shielding surface and the breathing chamber; wherein the ventilation portion is located at the bottom side of the shielding surface and the breathing chamber, and the ventilation portion communicating the inside space of the breathing chamber and the outside space of the base mask; a gas supply pump, including an inlet, an air extractor and an outlet; and a connecting tube, connecting to the communicating portion with one end, and connecting to the outlet with the other end; wherein, when the gas supply pump is operated, the air extractor draws the air from the inlet, the outlet delivers the air through the connecting tube to the inside space of the breathing chamber, and the air in the inside space of the breathing chamber expels through the ventilation portion to the outside space of the base mask.

### BRIEF DESCRIPTION OF THE DRAWINGS

The described embodiments may be better understood by reference to the following description and the accompanying drawings in which:

FIG. 1 is a perspective view of the face mask apparatus of the present disclosure.

FIG. 2 is an exploded view of the face mask apparatus of the present disclosure.

FIG. 3 is an exploded view of another angel of the face mask apparatus of the present disclosure.

FIG. 4 is a schematic view of wearing the face mask apparatus of the present disclosure.

FIG. 5 is a sectional schematic view of line V-V of FIG. 1 in operation of the present disclosure.

FIG. 6 is a perspective view of the another embodiment of the present disclosure.

FIG. 7 is a sectional schematic view of line VII-VII of FIG. 6 in operation of the present disclosure.

### DETAILED DESCRIPTION OF THE EXEMPLARY EMBODIMENTS

Reference will now be made in detail to the presently preferred embodiments of the disclosure, examples of which are illustrated in the accompanying drawings. Wherever possible, the same or similar reference numbers are used in the drawings and the description to refer to the same or like parts. It should be noted that the drawings are only schematic and are not to precise scale. The dimensions and the relative dimensions do not necessarily correspond to actual reductions to practice of the invention. The drawings are not intended to limit the disclosure to the precise scale and configuration disclosed.

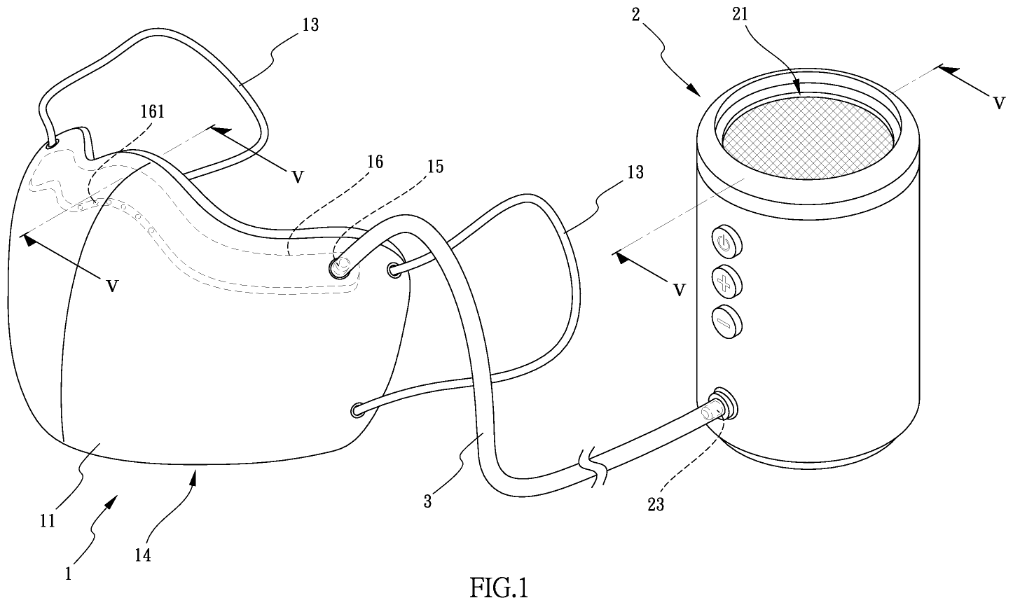

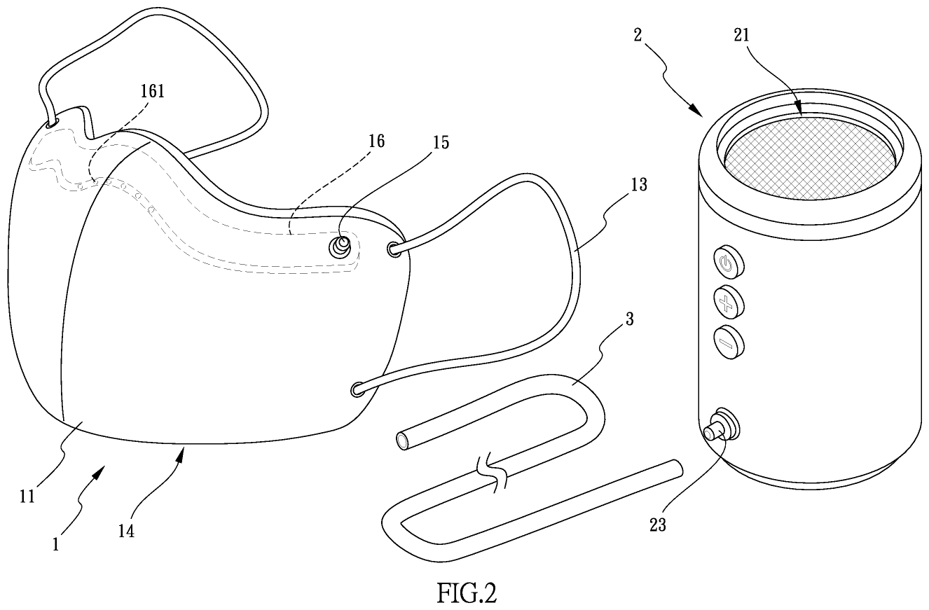

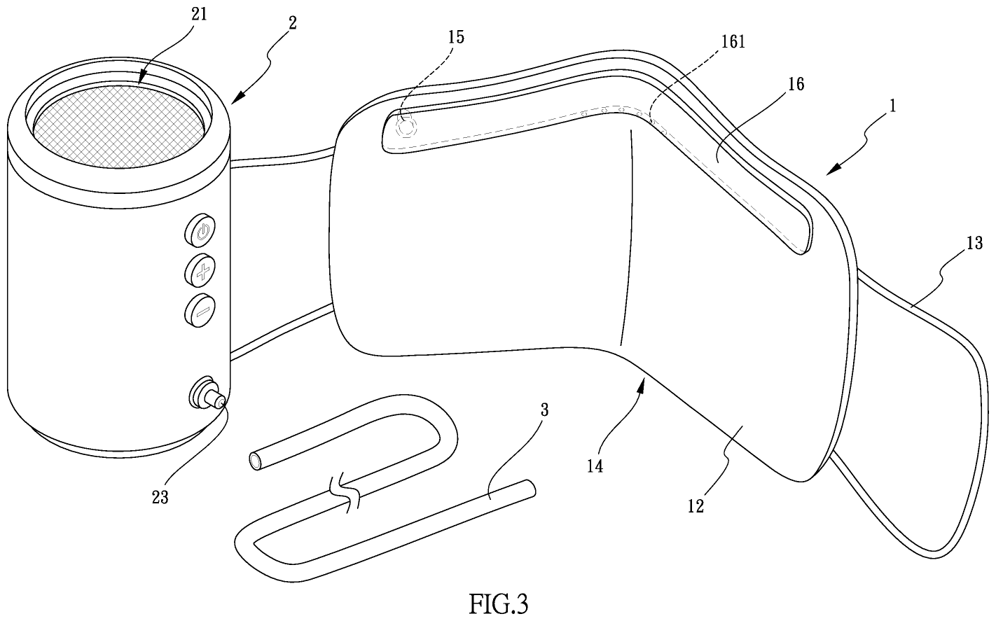

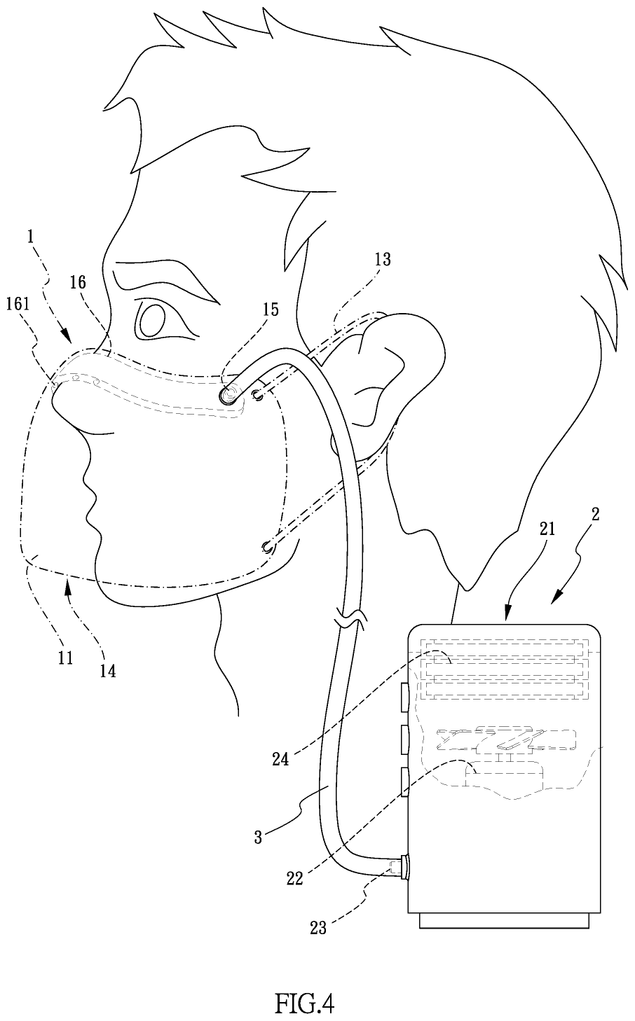

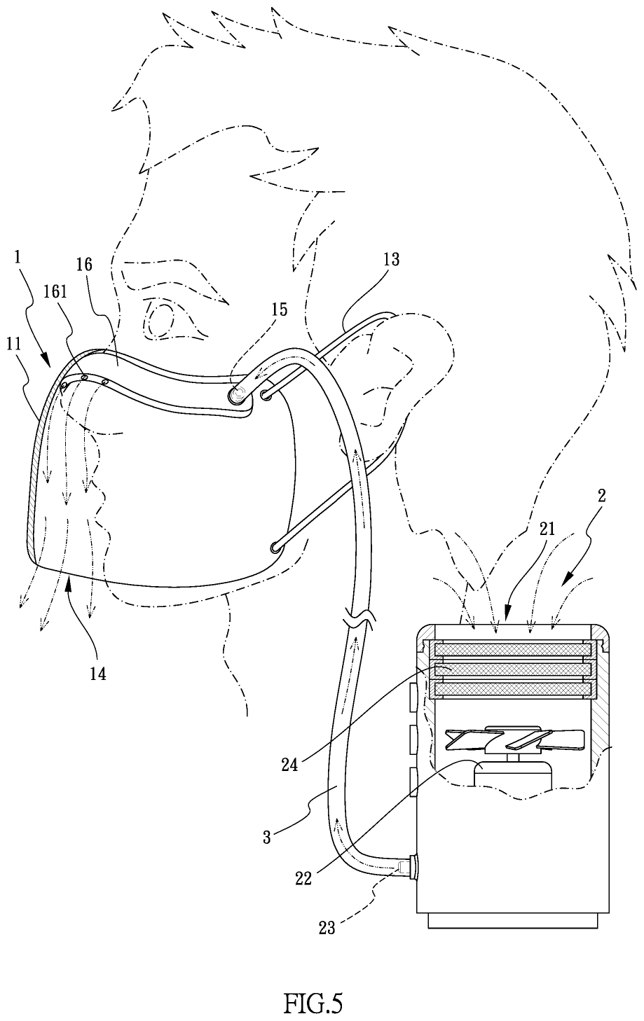

Referring to in FIG. 1 to FIG. 5, the present disclose provides face mask apparatus, including a base mask 1, a gas supply pump 2 and a connecting tube 3. The base mask 1 includes a shielding surface 11, a breathing chamber 12 and a pair of ear straps 13. In detail, the shielding surface 11 faces outward and shields the outside air from entering the inside space of the breathing chamber 12. The breathing chamber 12 is disposed opposite to the shielding surface 11, and the pair of ear straps 13 are disposed on two sides of the base mask 1 respectively. Further, the base mask 1 includes a ventilation portion 14, and a communicating portion 15 penetrating through the shielding surface 11 and the breathing chamber 12, in which the ventilation portion 14 is located at the bottom side of the shielding surface 11 and the breathing chamber 12, and communicated the inside space of the breathing chamber 12 and the outside space of the base mask 1.

Furthermore, the gas supply pump 2 includes an inlet 21, an air extractor 22 and an outlet 23, in which the inlet 21 communicates the outside space and the inside space of the gas supply pump 2 for receiving the air from outside. The air extractor is operated and pumped by power such as electricity, and the outlet 23 is used to deliver the air extracted by the gas supply pump 2 to the outside space of the gas supply pump 2.

Finally, the connecting tube 3 has one end connecting to the communicating portion 15 and the other end connecting to the outlet 23, which is used to deliver the air from the gas supply pump 2 to the inside part of the base mask 1.

As shown in FIG. 1 to FIG. 5, when the gas supply pump 2 is operated, the air extractor 22 draws the air from the inlet 21, the outlet 23 delivers the air through the connecting tube 3 to the inside space of the breathing chamber 12, and the excess air in the inside space of the breathing chamber 12 expels through the ventilation portion 14 to the outside space of the base mask 1. Therefore, the breathing chamber 12 is isolated from the outside air flowing into the inside space.

In operation, as shown in FIG. 1 to FIG. 5, the user can turn on the gas supply pump 2, wear the base mask 1 with the pair of ear straps 13. The shielding surface 11 shields the outside air from flowing into the inside space of the breathing chamber 12, and only the ventilation portion 14 is air communicated with outside space. When the gas supply pump 2 starts to pump, the air is delivered through the connecting tube 3 to the inside space of the breathing chamber 12. Since the air is sufficient, the exhaled air and the excess air in the breathing chamber 12 will flow out through the ventilation portion 14, and thereby generate an air curtain effect (or air door effect), which prevents the outside air from flowing in through the ventilation portion 14, and maintains the air in the breathing chamber 12 is all from the gas supply pump 2 or the user's exhaled air. Accordingly, this structure can shield infiltration of the external viruses and bacteria from the slit of the mask, and allows the user to breathe smoothly while wearing the mask.

Specifically, the detail features of the elements of the present disclosure are provided. As shown in FIG. 1 to FIG. 5, the base mask 1 further includes an air intake portion 16 in a tube shape and disposed in the base mask 1, and the air intake portion 16 includes a plurality of air flow paths 161. More specifically, the air intake portion 16 is connected to the communicating portion 15, and the plurality of air flow paths 161 are disposed in the air intake portion 16 dispersedly and communicating the air from the inside space of the breathing chamber to the outside space. This structure allows the air flowing into the inside space of the breathing chamber 12 quickly and evenly, so that the user can breathe more comfortably.

Further, as shown in FIG. 1 to FIG. 5, the gas supply pump 2 of the present disclosure includes a filter 24, filtering the air from the inlet 21, and preventing bacteria, viruses and dust from entering the inside space of breathing chamber 12.

Furthermore, as shown in FIG. 1 to FIG. 5, the base mask 1 of the present disclosure is arc-shaped, and the base mask 1 is partially protruded from the breathing chamber 12 toward the shielding surface 11. This structure enables the user to have more space to breath in the breathing chamber 12 when wearing the base mask 1.

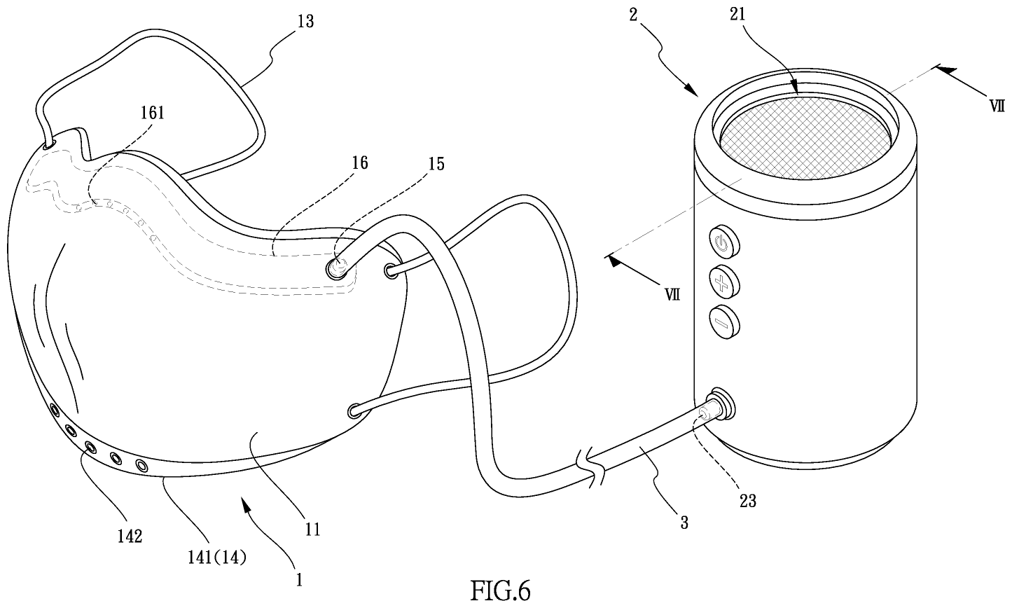

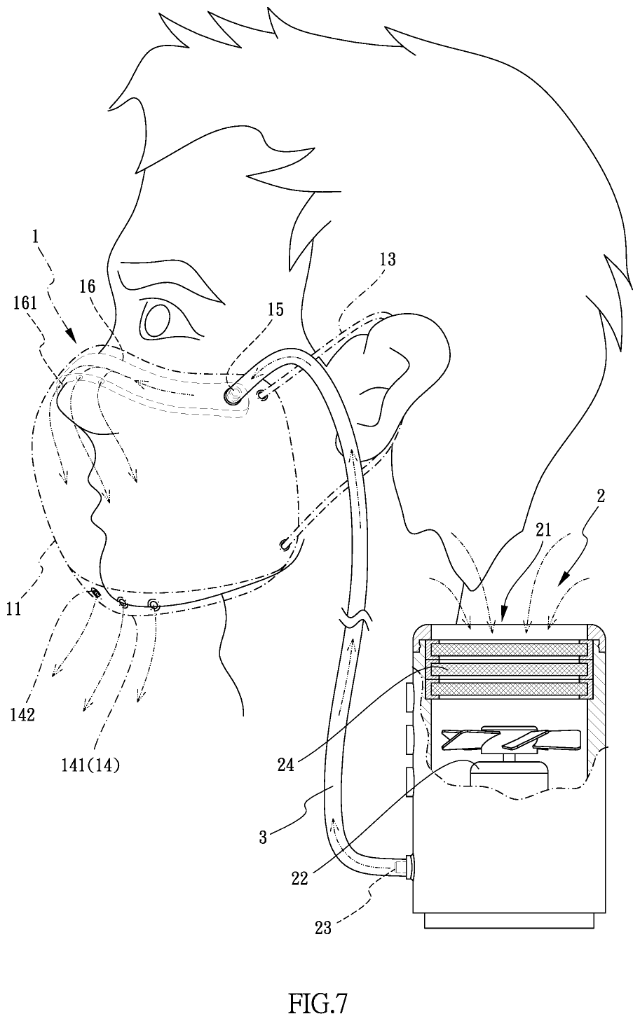

Moreover, as shown in FIG. 1 to FIG. 7, another embodiment of the present disclosure is provided. Specifically, the ventilation portion 14 of another embodiment includes a baffle 141 connecting to the bottom side of the shielding surface 11 and the breathing chamber 12, and the baffle 141 includes a plurality of air passageway 142 communicating the inside space of the breathing chamber 12 to the outside space of the base mask 1.

What is claimed is:

1. A face mask apparatus, comprising:
a base mask, including a shielding surface facing outward and shielding the outside air into the base mask; a breathing chamber opposite to the shielding surface; and a pair of ear straps disposed on two sides of the base mask respectively; wherein, the base mask further includes a ventilation portion, and a communicating portion penetrating through the shielding surface and the breathing chamber; wherein, the ventilation portion is located at the bottom side of the shielding surface and the breathing chamber, and the ventilation portion communicating the inside space of the breathing chamber and the outside space of the base mask;
a gas supply pump, including an inlet, an air extractor and an outlet; and
a connecting tube, connecting to the communicating portion with one end, and connecting to the outlet with the other end;
wherein, when the gas supply pump is operated, the air extractor draws the air from the inlet, the outlet delivers the air through the connecting tube to the inside space of the breathing chamber, and the air in the inside space of the breathing chamber expels through the ventilation portion to the outside space of the base mask.

2. The face mask apparatus according to claim 1, wherein the base mask further includes an air intake portion disposed in the base mask and connected with the communicating portion; wherein, the air intake portion includes a plurality of air flow paths communicating the air from the inside space of the breathing chamber to the outside space.

3. The face mask apparatus according to claim 1, wherein the gas supply pump further includes a filter, filtering the air from the inlet.

4. The face mask apparatus according to claim 1, wherein the ventilation portion further includes a baffle connecting the bottom side of the shielding surface and the breathing chamber; wherein, the baffle includes a plurality of air passageway communicating the air from the inside space of the breathing chamber to the outside of the base mask.
